(19) United States
(12) Patent Application Publication
(10) Pub. No.: US 2017/0108813 A1
(43) Pub. Date: Apr. 20, 2017

(54) SHEET FEEDING APPARATUS AND IMAGE FORMING APPARATUS

(71) Applicant: CANON KABUSHIKI KAISHA, Tokyo (JP)

(72) Inventors: Koki Sato, Nagareyama-shi (JP); Hiroto Koga, Abiko-shi (JP)

(21) Appl. No.: 15/284,761

(22) Filed: Oct. 4, 2016

(30) Foreign Application Priority Data
Oct. 19, 2015 (JP) 2015-205463

(51) Int. Cl. G03G 15/00; B65H 7/04; B65H 9/06; B65H 1/04; B65H 3/06

(52) U.S. Cl. CPC G03G 15/6529; B65H 1/04; B65H 3/0684; B65H 9/06; B65H 7/04; B65H 2801/12

(57) ABSTRACT

A sheet feeding apparatus includes an upstream end regulation unit configured to move between a regulating position where the regulation unit is protruded from the sheet support surface and regulates a sheet supported on the sheet support surface from moving upstream in the sheet conveyance direction, and a retracted position where the regulation unit is pushed down into the sheet support surface from the regulating position. The upstream end regulation unit is positioned within an area where it is overlapped with a sheet placed on the reference position, and configured to move from the retracted position to the regulating position in a state where there are no sheets on the upstream end regulating unit.

### BACKGROUND OF THE INVENTION

Field of the Invention

The present invention relates to a sheet feeding apparatus and an image forming apparatus.

Description of the Related Art

Conventionally, image forming apparatuses such as printers and electro-photographic copying machines are equipped with a sheet feeding apparatus that separates sheets supported on a sheet feed tray one by one and feeds the sheets. A widespread type of sheet feeding apparatus is equipped with a regulation member that regulates the respective end portions of the supported sheets, so as to align the supported sheets on the sheet feed tray and enable stable sheet feed. For example, Japanese Patent Laid-open No. 2008-81247 teaches a sheet feeding apparatus having an upstream end regulation member arranged at a position regulating an upstream end, serving as a trailing end, in the sheet conveyance direction of the supported sheets on the sheet feed tray. According to the sheet feeding apparatus, the upstream end regulation member can prevent the supported sheets from retreating upstream, by elevating a sheet supporting portion provided on the sheet feed tray. Further, Japanese Patent Laid-open No. 2005-200149 teaches a sheet feeding apparatus having an upstream end regulation member provided retractably with respect to a sheet support surface, so that the regulation member will not interfere when a user places sheets on the sheet feed tray.

If the sheet feed tray does not have a sheet supporting portion, the supported sheets will not be retreated upstream by the reason described above. However, if an uppermost sheet of the supported sheets causes the second sheet to be subjected to double feed to a separation roller, an upstream end of the uppermost sheet may flick a downstream end of the second sheet, and cause the second sheet to be retreated upstream. Providing the upstream end regulation member is effective in suppressing the retreating of the second sheet to the upstream direction.

However, according to a sheet feeding apparatus taught in Japanese Unexamined Patent Application Publication No. 2008-81247, if supported sheets are present, the upstream end regulation member cannot be retracted from the sheet support surface, and the upstream end regulation member will remain protruded from the sheet support surface. Therefore, if the user removes the supported sheets remaining on the sheet feed tray after the image forming process is completed, the supported sheets may get caught by the upstream end regulation member, by which the workability is deteriorated.

According to the sheet feeding apparatus disclosed in the above-mentioned Japanese Unexamined Patent Application Publication No. 2005-200149, the upstream end regulation member is retractable from the sheet support surface even when supported sheets are present on the surface, but the user must retract the upstream end regulation member by applying force to the member. Therefore, similar to the sheet feeding apparatus disclosed in Japanese Unexamined Patent Application Publication No. 2008-81247, the workability of the user removing the supported sheets from the sheet feed tray after the image forming process is completed is not good.

### SUMMARY OF THE INVENTION

According to one aspect of the invention, a sheet feeding apparatus comprising: a sheet supporting portion comprising a sheet support surface configured to support a sheet; a feed roller configured to abut against and feed an uppermost sheet of sheets supported on the sheet support surface; a separation unit arranged downstream, in a sheet conveyance direction, of the feed roller, and configured to separate and convey the sheets fed via the feed roller one by one; and a regulation unit configured to move between a regulating position where the regulation unit is protruded from the sheet support surface and regulates a sheet supported on the sheet support surface from moving upstream in the sheet conveyance direction, and a retracted position where the regulation unit is pushed down into the sheet support surface from the regulating position, wherein the regulation unit is configured to be pushed down by a sheet positioned at a reference position on the sheet support surface, and in a case where the sheet moves from the reference position toward the separation unit and is not present on the regulation unit, the regulation unit moves from the retracted position to the regulating position to regulate the movement of the sheet.

Further features of the present invention will become apparent from the following description of exemplary embodiments with reference to the attached drawings.

### BRIEF DESCRIPTION OF THE DRAWINGS

FIG. 1 illustrates a cross-sectional view of a general configuration of a color laser printer, serving as an example of an image forming apparatus having a sheet feeding apparatus according to a preferred embodiment of the present invention.

FIG. 2 is a perspective view illustrating a configuration of the sheet feeding apparatus according to the present embodiment.

FIG. 3 is a side view illustrating a state where a sheet is not supported on the sheet feeding apparatus according to the present embodiment.

FIG. 4A is a side view illustrating a state where two sheets are supported at a reference position on the sheet feeding apparatus according to the present embodiment.

FIG. 4B is a side view illustrating a state where an uppermost sheet is separated by a separation roller in the sheet feeding apparatus according to the present embodiment.

FIG. 5A is a side view illustrating a state where a second sheet is stopped at a separation unit according to a prior art sheet feeding apparatus that is not equipped with a trailing end regulating member.

FIG. 5B is a side view illustrating a state where the second sheet is flicked rearward by a trailing end portion of an uppermost sheet in a prior art sheet feeding apparatus that is not equipped with the trailing end regulating member.

FIG. 6 is a general block diagram of a control unit of the image forming apparatus according to the present embodiment.

### DESCRIPTION OF THE EMBODIMENTS

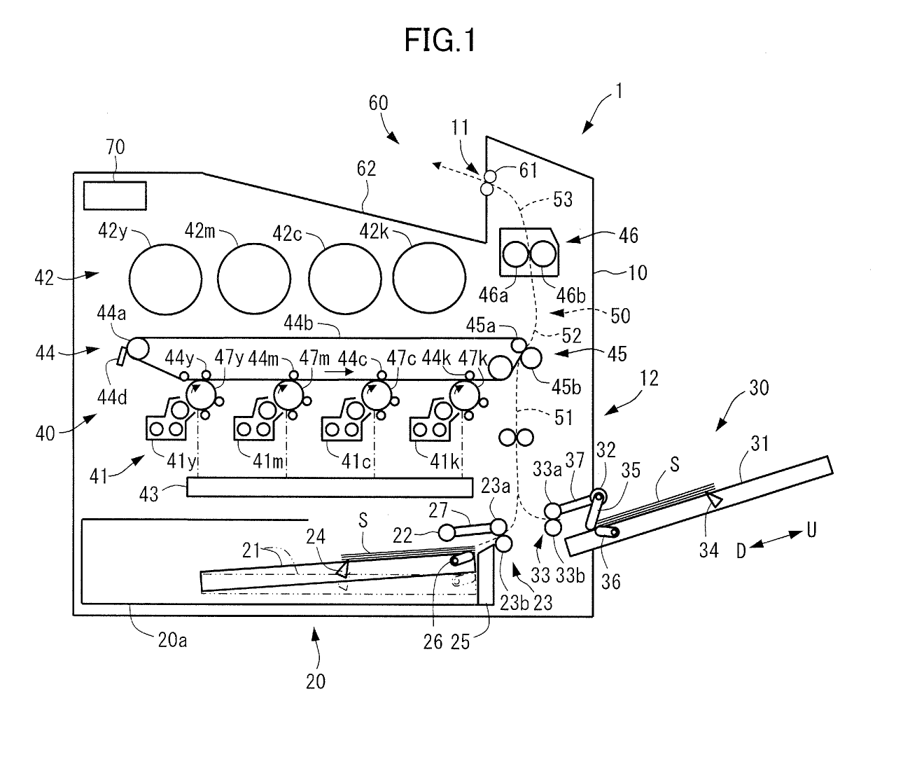

Now, a preferred embodiment of the present invention will be described in detail with reference to FIGS. 1 through 4B and FIG. 6. In the present embodiment, a tandem-type full-color printer is described as an example of an image forming apparatus. However, the present invention is not restricted to tandem-type image forming apparatuses, and other types of image forming apparatuses can be adopted. The image forming apparatus does not have to be full-color, and it can be monochrome or mono-color.

At first, a configuration of an image forming apparatus 1 illustrated in FIG. 1 will be described. The image forming apparatus 1 includes an image forming apparatus body (hereinafter referred to as apparatus body) 10. Further, the apparatus body 10 includes a body sheet feeding unit, serving as a sheet feeding apparatus, 20, a manual sheet feed portion, serving as a sheet feeding apparatus, 30, an image forming unit 40, a sheet conveyance unit 50, a sheet discharge portion 60, and a control unit 70. A sheet S as recording material on which a toner image is to be formed can be, as specific examples, a normal paper, a resin sheet as a substitute for normal paper, a postcard, a cardboard, an OHP sheet, and so on.

The sheet feeding unit 20 has a sheet cassette 20a configured to store sheets S such as recording paper, a sheet feed tray 21 configured to support the sheet S and capable of being elevated, a feed roller 22 and a separation unit 23, and feeds the sheets S to the image forming unit 40. The details of the sheet feeding unit 20 will be described later.

A manual sheet feed portion 30 includes a sheet feed tray 31 supporting the sheets S, a feed roller 32 and a separation unit 33, and feeds the sheet S to the image forming unit 40. The details of the manual sheet feed portion 30 will be described later.

The image forming unit 40 includes an image forming unit 41, a toner bottle 42, a laser scanner 43, an intermediate transfer unit 44, a secondary transfer portion 45 and a fixing unit 46, and forms images.

The image forming unit 41 includes four image forming units, 41y, 41m, 41c and 41k, for forming toner images of four colors, which are yellow (y), magenta (m), cyan (c) and black (k). The units can respectively be detached from the apparatus body 10 by the user. For example, the image forming unit 41y includes a photosensitive drum 47y, serving as an image bearing member, on which a toner image is formed, and a charging roller, a developing roller, a drum cleaning blade, a toner and the like not shown. Further, toner is supplied to the image forming unit 41y from the toner bottle 4y having toner filled therein. The other image forming units 41m, 41c and 41k adopt similar structures, so detailed descriptions thereof are omitted.

The laser scanner 43 exposes the surfaces of the photosensitive drums 47y, 47m, 47c and 47k, and forms electrostatic latent images on the surfaces of the photosensitive drums 47y, 47m, 47c and 47k.

The intermediate transfer unit 44 is arranged above image forming units 41y, 41m, 41c and 41k. The intermediate transfer unit 44 includes a plurality of rollers such as a driving roller 44a and primary transfer rollers 44y, 44m, 44c and 44k, an intermediate transfer belt 44b wound around the rollers, a cleaning blade 44d, and so on. The primary transfer rollers 44y, 44m, 44c and 44k are respectively arranged to face the photosensitive drums 47y, 47m, 47c and 47k, and contact the intermediate transfer belt 44b. The toner images having negative polarity formed on the photosensitive drums 47y, 47m, 47c and 47k are sequentially superimposed and transferred to the intermediate transfer belt 44b by applying transfer bias of positive polarity from the primary transfer roller 44y, 44m, 44c and 44k to the intermediate transfer belt 44b. Thereby, a full-color image is formed on the intermediate transfer belt 44b. The cleaning blade 44d contacts a portion of the intermediate transfer belt 44b and removes residual toner from the intermediate transfer belt 44b.

The secondary transfer portion 45 includes a secondary transfer inner roller 45a and a secondary transfer outer roller 45b. The full-color image formed on the intermediate transfer belt 44b is transferred to the sheet S by applying a secondary transfer bias of positive polarity to the secondary transfer outer roller 45b. The secondary transfer inner roller 45a stretches the intermediate transfer belt 44b in the inner side of the intermediate transfer belt 44b, and the secondary transfer outer roller 45b is provided at a position opposing to the secondary transfer inner roller 45a with the intermediate transfer belt 44b intervened.

The fixing unit 46 includes a fixing roller 46a and a pressing roller 46b. The toner image transferred to the sheet S is heated and pressed in a state where the sheet S is nipped and conveyed between the fixing roller 46a and the pressing roller 46b, and fixed to the sheet S.

A sheet conveyance unit 50 includes a pre-secondary-transfer conveyance path 51, a pre-fixing conveyance path 52 and a discharge path 53, and conveys the sheet S fed from the sheet feeding unit 20 or the manual sheet feed portion 30 from the image forming unit 40 to the sheet discharge portion 60.

The sheet discharge portion 60 includes a discharge roller pair 61 arranged downstream in the discharge path 53, and a discharge tray 62 arranged downstream of the discharge roller pair 61. The discharge roller pair 61 feeds the sheet S conveyed through the discharge path 53 from a nip portion, and the sheet S is discharged through a discharge port 11 formed on the apparatus body 10 onto a discharge tray 62.

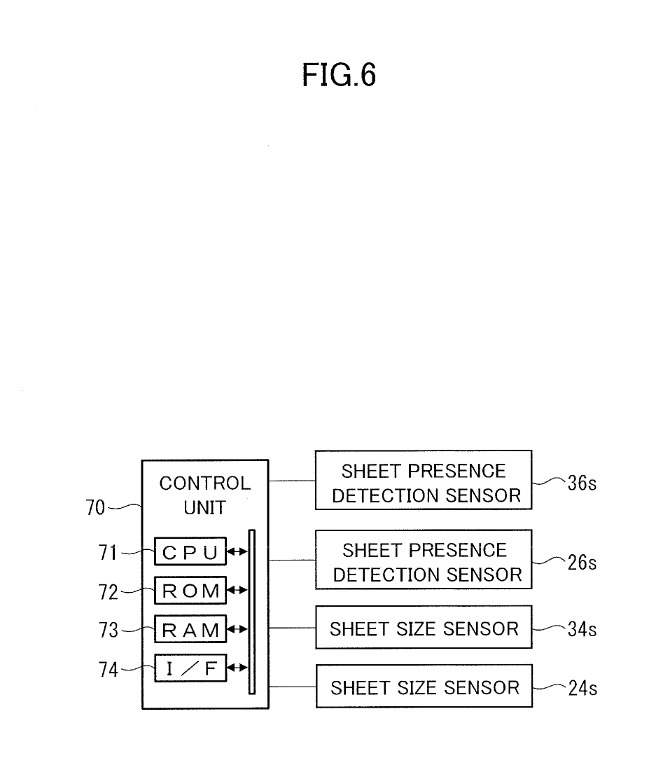

As illustrated in FIG. 6, the control unit 70 is composed of a computer, and includes, for example, a CPU 71, a ROM 72 storing programs controlling respective units, a RAM 73 temporarily storing data, and an input/output circuit (I/F) 74 inputting/outputting signals from/to an exterior. A sheet presence detection sensor 36s of the manual sheet feed portion 30, a sheet presence detection sensor 26s of the sheet feeding unit 20, a sheet size sensor 34s of a trailing end regulation member 34 of the manual sheet feed portion 30, and a sheet size sensor 24s of a trailing end regulation member 24 of the sheet feeding unit 20, which are described later, are connected to the control unit 70.

In a state where image forming operation is started in the image forming apparatus 1 configured as above, at first, the photosensitive drums 47y, 47m, 47c and 47k are rotated, and the surface of the drums are charged by the charging rollers. Thereafter, laser beams are irradiated from the laser scanner 43 to the photosensitive drums 47y, 47m, 47c and 47k based on image information, and electrostatic latent images are formed on the surfaces of the photosensitive drums 47y, 47m, 47c and 47k. The electrostatic latent images are developed by having toner attach to the electrostatic latent images and are visualized as toner images, and the toner images are transferred to the intermediate transfer belt 44b.

On the other hand, simultaneously as the operation for forming toner images, the feed roller 22 or 32 rotates, separating and feeding an uppermost sheet S from the sheet feed tray 21 or 31. Then, the sheet S is conveyed to the secondary transfer portion 45 via the pre-secondary-transfer conveyance path 51 at a matched timing with the toner image on the intermediate transfer belt 44b. Further, after image is transferred to the sheet S from the intermediate transfer belt 44b, the sheet S is conveyed to the fixing unit 46, where the unfixed toner image is heated, pressed, and fixed to the surface of the sheet S, and thereafter, the sheet S is discharged via the discharge roller pair 61 through the discharge port 11 and supported on the discharge tray 62.

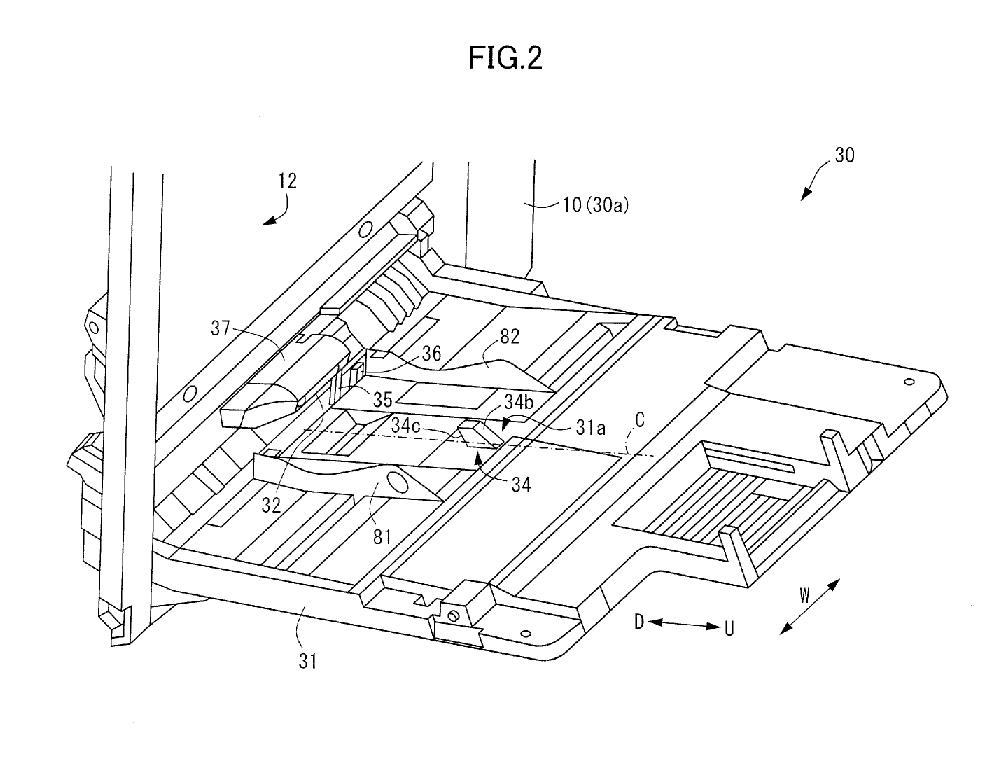

Next, a configuration of the manual sheet feed portion 30 will be described in detail with reference to FIG. 2. The manual sheet feed portion 30 includes an apparatus body 30a, the sheet feed tray 31, the feed roller 32, a separation unit 33 (refer to FIG. 1), a trailing end regulation member, serving as a regulating unit, 34, and a leading end regulation member, serving as a downstream end regulation unit, 35. The apparatus body 30a also serves as the apparatus body 10 of the image forming apparatus 1.

The sheet feed tray 31 is provided on the apparatus body 10 and includes a sheet support surface 31a capable of supporting sheets S. The sheet feed tray 31 is supported pivotably around a lower side of an opening 12 formed at a right side portion of the apparatus body 10 via a support shaft not shown provided horizontally along a front-rear direction of the apparatus body 10. The sheet feed tray 31 is capable of being opened and closed between a stored position, where the tray is positioned perpendicularly and stored in the apparatus body 10, and a sheet support position (refer to FIG. 2), where the tray is positioned approximately horizontally and capable of supporting the sheets S, by pivotably within a range of, for example, approximately 70 to 80 degrees. That is, the sheet feed tray 31 is a so-called manual sheet-feeding tray arranged so that a downstream side in a sheet conveyance direction of the sheet support surface 31a is inclined downward.

The sheet feed tray 31 can feed various-sized sheets, from a minimum size of postcard size to a maximum size of A3 size, and a variety of sheets such as envelopes and postcards. As illustrated in FIG. 2, a pair of regulation members 81 and 82 configured to regulate end positions in a width direction W of the supported sheet orthogonal to a sheet feeding direction is disposed movably on the sheet feed tray 31 in a width direction W, so as to feed the various types of sheets in a stable manner. The sheet feed tray 31 has an interlocking mechanism not shown that interlocks the respective regulation members 81 and 82 so that they move mutually in opposite directions in the width direction W. A straight line in a sheet conveyance direction passing a center in the width direction W of the feed roller 32 is set as a conveyance center line C, serving as a conveyance reference line, being a reference of conveyance of the sheet S. Therefore, the respective regulation members 81 and 82 move symmetrically in the width direction W with respect to the center line C to regulate side ends of the sheet S, thereby conveying the sheet S along the conveyance center line C at the center of the width direction W of the sheet S.

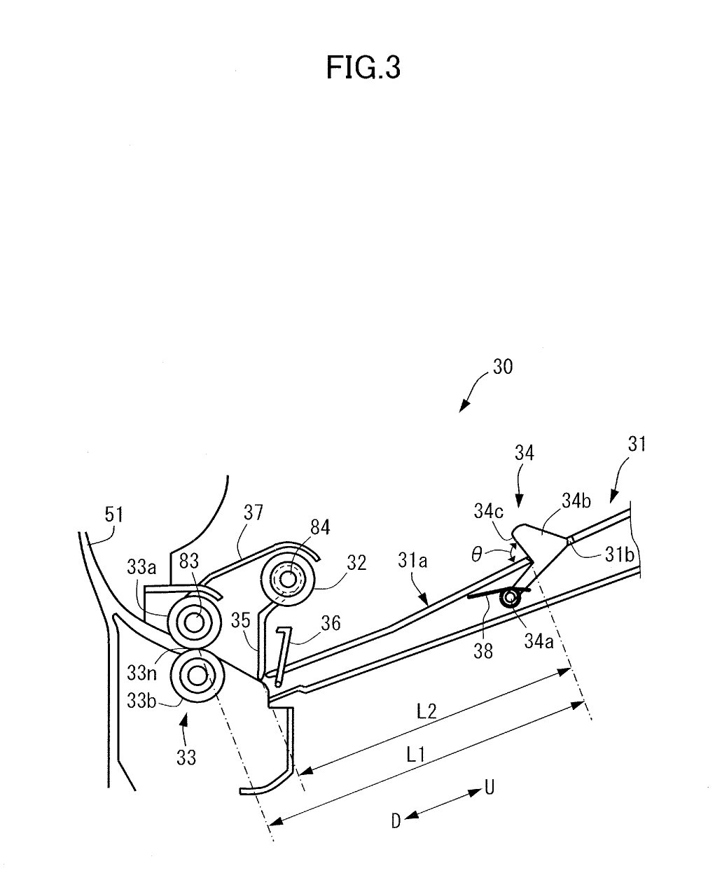

As illustrated in FIG. 3, the separation unit 33 is provided in the apparatus body 10 downstream D in a sheet conveyance direction of the feed roller 32, includes a feed roller 33a and a retard roller 33b, and is configured to separate and convey the sheet S fed via the feed roller 32 one by one. The feed roller 33a is connected to a feed roller shaft 83 and revolves integrally therewith. The feed roller shaft 83 is revolved by a drive unit not shown. Therefore, the feed roller 33a is revolved by the rotation transmitted from the drive unit further transmitted thereto via the feed roller shaft 83. A driving power of a rotation in an opposite direction as the direction feeding the sheet S is supplied to the retard roller 33b from a driving source via a torque limiter not shown. The retard roller 33b is not limited to a roller having driving power transmitted thereto, and it can be mounted revolvably to the sheet feed tray 31 via a torque limiter to a fixed roller shaft or a roller shaft capable of being driven in reverse revolution via a wound spring.

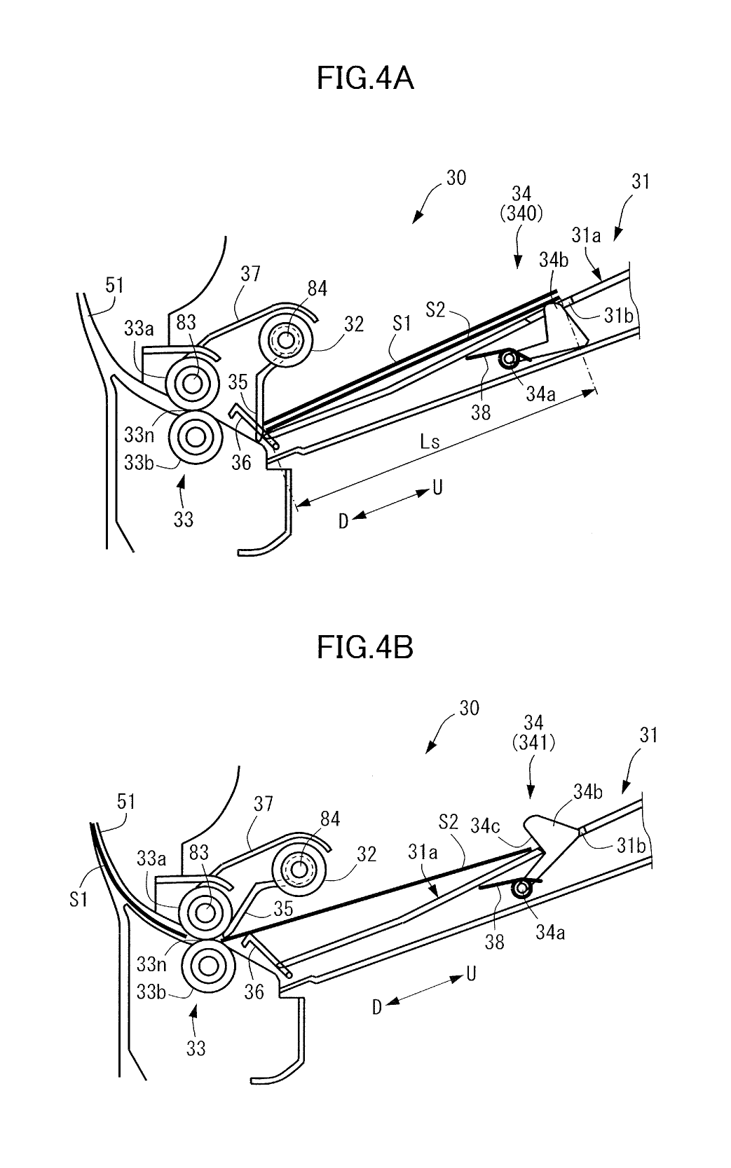

The feed roller 32 is provided in the apparatus body 10, and contacts an uppermost sheet of the sheets S supported at a predetermined reference position on the sheet support surface 31a to feed the sheet. The predetermined reference position according to the present embodiment refers to a position where a maximum rated number of supportable sheets S on the sheet feed tray 31 can be supported at a position separated by a predetermined distance from the separation unit 33, and also a position where the lowered feed roller 32 contacts the uppermost sheet of the supported sheet S, as illustrated in FIG. 4A.

The feed roller 32 is supported swingably by a pickup arm 37 disposed pivotably in up and down directions with the feed roller shaft 83 serving as the support shaft. A feed roller shaft 84 is provided on the pickup arm 37, and the feed roller 32 is revolvably supported on the feed roller shaft 84. The rotation of the feed roller shaft 83 is transmitted to the feed roller shaft 84 via a gear train not shown provided on the pickup arm 37, and rotates the feed roller 32 in the sheet feeding direction.

The pickup arm 37 is configured swingably in a vertical direction by a cam mechanism not shown, and normally, as illustrated in FIG. 3, the pickup arm 37 is retained at a standby position retaining the feed roller 32 above the sheet S. Further, the pickup arm 37 is lowered by the cam mechanism during sheet feed, so that the feed roller 32 contacts the uppermost sheet of the sheets S supported on the sheet feed tray 31, revolves by the drive from a drive unit transmitted to the feed roller shaft 84, and feeds sheets S.

A leading end regulation member 35 is composed of a lever revolving around the feed roller shaft 84, and the regulation member 35 is arranged relatively retractably with respect to a sheet conveyance path from a position on a downstream end of the sheet S supported at the reference position (refer to FIG. 4A) to a position of the separation unit 33 (refer to FIG. 4B). In the present embodiment, the leading end regulation member 35 is disposed movably with respect to the apparatus body 10, and disposed retractably on the sheet conveyance path, extending from a downstream end of the sheets S supported at the reference position to the separation unit 33. The leading end regulation member 35 can be attached to the feed roller shaft 84 via a one-way clutch, for example, that enables the regulation member 35 to be revolved in a left rotating direction and not revolve in the right rotating direction of FIG. 3. Thus, as illustrated in FIG. 4A, the leading end regulation member 35 protrudes to the sheet conveyance path when the feed roller 32 and the separation unit 33 are stopped, and regulates the sheet from moving downstream D in a sheet conveyance direction by abutting against a downstream end of the sheets S supported at the reference position. Thereby, the user can support the sheets S at the reference position. Moreover, as illustrated in FIG. 4B, the leading end regulation member 35 is retracted from the sheet conveyance path when the feed roller 32 and the separation unit 33 are driven, releasing the downstream end of the sheet S supported at the reference position and allowing the sheet S to move downstream D in the sheet conveyance direction. Thereby, the sheet S can be fed. That is, the leading end regulation member 35 is configured to abut against the downstream end of the sheet S supported on the sheet support surface 31a to position the sheet S at the reference position in the sheet conveyance direction, and in a state where the feed roller 32 and the separation unit 33 are operated, configured to release the downstream end of the sheet S supported at the reference position and allow the sheet S to move downstream D in the sheet conveyance direction.

A detection lever 36 of the sheet presence detection sensor 36s is provided in a vicinity upstream U in the sheet conveyance direction of the leading end regulation member 35. The sheet presence detection sensor 36s has a detection lever 36 whose inclination angle varies according to whether a sheet S exists on the sheet support surface 31a, and the sensor 36c can transit an electric signal regarding the inclination angle of the detection lever 36 to the control unit 70. According to the present embodiment, the sheet presence detection sensor 36s changes the electric signal based on whether the detection lever 36 is inclined upstream (refer to FIG. 3), or inclined downstream (refer to FIG. 4A). In a state where the control unit 70 receives a signal indicating that the detection lever 36 is inclined upstream, it is determined that the sheet S is not supported, and in a state where the control unit 70 receives a signal indicating that the detection lever 36 is inclined downstream, it is determined that the sheet S is supported at the reference position. That is, the control unit 70 can detect whether the sheet S is supported at the reference position on the sheet support surface 31a based on the electric signal transmitted from the sheet presence detection sensor 36s.

As illustrated in FIG. 3, the trailing end regulation member 34 is provided on the sheet feed tray 31, and in the present embodiment, the member 34 has an L-shape when viewed from the side. The trailing end regulation member 34 includes a support shaft 34a having an axial direction corresponding to the width direction W and arranged at one end portion, a retractable portion 34b composed of the other end portion, and an abutment surface 34c formed on the retractable portion 34b and facing downstream D in the sheet conveyance direction. The retractable portion 34b is arranged retractably with respect to the sheet support surface 31a through a through hole 31b formed on a part of the sheet support surface 31a. That is, the trailing end regulation member 34 is provided on the sheet feed tray 31, and configured movably between a regulating position 341 protruding from the sheet support surface 31a and regulating the sheet supported on the sheet support surface 31a from moving upstream U in the sheet conveyance direction (refer to FIG. 4B) and a retracted position 340 pushed down into the sheet support surface 31a from the regulating position 341 (refer to FIG. 4A).

In a state where the retractable portion 34b protrudes from the sheet support surface 31a, the retractable portion 34b regulates the sheet S supported on the sheet support surface 31a from moving upstream U in the sheet conveyance direction. That is, the trailing end regulation member 34 can regulate the sheet S supported on the sheet support surface 31a from moving upstream U in the sheet conveyance direction. In the present embodiment, the retractable portion 34b of the trailing end regulation member is arranged at a position overlapped with a trailing end portion of the postcard placed at the reference position.

The support shaft 34a is supported pivotably within the sheet feed tray 31, and the retractable portion 34b is biased toward a direction to protrude from the sheet support surface 31a via a bias spring 38 composed of a torsion coil spring. The biasing force of the bias spring 38 is set to such a level that the retractable portion 34b is pushed down into the through hole 31b of the sheet support surface 31a when a single sheet S is mounted on the retractable portion 34b. That is, the trailing end regulation member 34 is arranged within an area overlapped with the sheet placed at the reference position, and configured to move from the retracted position 340 to the regulating position 341 when there are no sheets S on the retractable portion 34b.

The abutment surface 34c is configured so that the sheet S can be abutted thereto from the downstream side D in the sheet conveyance direction, in a state where the retractable portion 34b is protruded from the sheet support surface 31a, and configured so that an inclination angle θ with respect to the sheet support surface 31a is set to an acute angle of approximately 60 to 80 degrees, for example. Thereby, even if the sheet S is flicked at the separation unit 33 and hits against the abutment surface 34c from the downstream side D in the sheet conveyance direction, the trailing end of the sheet S can be prevented from bounding upward at the abutment surface 34c, and the sheet can be regulated reliably with an improved trailing end regulating performance. The inclination angle A with respect to the sheet support surface 31a is not restricted to 60 to 80 degrees, and can be other acute angles, or a right angle, or an obtuse angle.

If at least one of the sheets S supported on the sheet support surface 31a is positioned at the reference position, the retractable portion 34b of the trailing end regulation member 34 is pushed down into the sheet support surface 31a by the weight of the at least one of the sheets S. Further, if all the sheets S supported on the sheet support surface 31a are displaced toward the separation unit 33 from the reference position, the retractable portion 34b of the trailing end regulation member 34 protrudes from the sheet support surface 31a and regulates the sheet S from moving upstream U in the sheet conveyance direction.

In the present embodiment, the trailing end regulation member 34 also serves as a sheet size sensor, serving as a sheet size detection unit, 34s configured to detect the size of the sheet S supported on the sheet support surface 31a. In the present embodiment, the trailing end regulation member 34 is interlocked with the sheet size sensor 34s, and a retracting movement of the retractable portion 34b of the trailing end regulation member 34 with respect to the sheet support surface 31a is converted into an electric signal by the sheet size sensor 34s and transmitted to the control unit 70. Thereby, the control unit 70 can detect whether the length in the sheet conveyance direction of the sheet S supported on the sheet support surface 31a is longer or shorter than a predetermined length based on the electric signal from the trailing end regulation member 34. A method for detecting sheet size utilizing the sheet size sensor 34s can include, for example, providing a plurality of sheet size sensors on the sheet feed tray 31, and determining the size of the sheet by the control unit 70 based on which sheet size sensor has detected the supported sheet.

Now, if a distance from the trailing end regulation member 34 to a nip portion 33n of the separation unit 33 is denoted as L1, a distance from the trailing end regulation member 34 to the leading end regulation member 35 is denoted as L2, and a length in the sheet conveyance direction of the minimum sized sheet S is denoted as Ls (refer to FIG. 4A), a relationship of L1>Ls>L2 is satisfied. That is, the trailing end regulation member 34 and the leading end regulation member 35 are arranged at a position satisfying the relationship of L1>Ls>L2.

Next, the configuration of the sheet feeding unit 20 will be described with reference to FIG. 1. The sheet feeding unit 20 includes the apparatus body 10, the sheet cassette 20a, the sheet feed tray 21, the feed roller 22, the separation unit 23, a trailing end regulation member, serving as a regulation unit, 24, a leading end regulation member, serving as a downstream end regulation unit, 25, and a detection lever 26 of the sheet presence detection sensor 26s. The apparatus body 10 also serves as the apparatus body 10 of the image forming apparatus 1. The feed roller 22 is supported revolvably, for example, at a position fixed by a supporting member 27. The sheet feed tray 21 can be elevated and lowered while supporting the sheet S, and in a state where the tray is lowered, the user can place the sheet S on the tray, and in a state where the tray is elevated, the uppermost sheet contacts the feed roller 22. In the present embodiment, the position of the feed roller 22 is fixed by the supporting member 27, but the invention is not restricted to this example, and the feed roller 22 can also be elevated and lowered, similar to the feed roller 32. Further, the trailing end regulation member 24 also serves as a sheet size sensor, serving as a sheet size detection unit, 24s. According to the present embodiment, the trailing end regulation member 24 is interlocked with the sheet size sensor 24s, and the retracting movement of the trailing end regulation member 24 is converted into an electric signal via the sheet size sensor 24s, and the signal can be transmitted to the control unit 70.

The leading end regulation member 25 is arranged in a fixed manner to the sheet cassette 20a positioned downstream in the sheet conveyance direction of the sheet feed tray 21, and arranged relatively retractably from the sheet conveyance path extending from the downstream end of the sheet S supported at the reference position to the separation unit 23. In the present embodiment, the leading end regulation member 25 is fixed in a non-movable manner via the sheet cassette 20a to the apparatus body 10, but through the elevation of the sheet feed tray 21, the sheet conveyance path extending from the downstream end of the sheet S supported at the reference position to the separation unit 23 is elevated. By having the sheet conveyance path elevate along with the elevation of the sheet feed tray 21 with respect to the fixed leading end regulation member 25, the leading end regulation member 25 is made relatively retractable with respect to the sheet conveyance path.

The separation unit 23 is provided on the apparatus body 10 at a position downstream in the sheet conveyance direction of the feed roller 22, includes a feed roller 23a and a retard roller 23b, and is configured to separate and convey the sheets S fed via the feed roller 22 one sheet at a time. The other configurations of the sheet feeding unit 20 are equivalent to the manual sheet feed portion 30, so that detailed descriptions thereof are omitted.

Next, an operation of the manual sheet feed portion 30 according to the present embodiment will be described in detail with respect to FIGS. 3, 4A and 4B. In the present embodiment, a postcard, that has a smaller size, greater basis weight and higher stiffness compared to normal recording paper, is used as the sheets S1 and S2.

As illustrated in FIG. 3, when a user opens the sheet feed tray 31 of the manual sheet feed portion 30, the trailing end regulation member 34 is biased by the bias spring 38, and the retractable portion 34b protrudes from the sheet support surface 31a. The pickup arm 37 retains the feed roller 32 at a standby position, that is, above the sheet support surface 31a. In a state where the feed roller 32 and the separation unit 33 are stopped, the leading end regulation member 35 protrudes to the sheet conveyance path. The detection lever 36 of the sheet presence detection sensor 36s is inclined upstream, so the control unit 70 determines that there are no sheets supported on the sheet support surface 31a.

In this state, as illustrated in FIG. 4A, if the user places two sheets S1 and S2 on the sheet support surface 31a, or if three or more sheets are supported on the sheet support surface 31a and one or more sheets are fed therefrom, leaving two remaining sheets on the surface 31a, the downstream ends of the respective sheets S1 and S2 are abutted against the leading end regulation member 35, and the respective sheets S1 and S2 are positioned at the reference position. The downstream ends of the respective sheets S1 and S2 revolve the detection lever downstream, and the control unit 70 determines that the sheet S is supported at the reference position of the sheet support surface 31a. At this time, the upstream end of the respective sheets S1 and S2 overlap with the retractable portion 34b of the trailing end regulation member 34, and pushes down the retractable portion 34b into the sheet support surface 31a, that is, to the retracted position 340, against the bias spring 38. Thereby, when the image forming process is completed, for example, and the user removes the sheets S remaining on the sheet feed tray 31, the sheets S will not get caught by the trailing end regulation member 34, and the workability can be improved.

In feeding the sheet S, the pickup arm 37 is lowered and the feed roller 32 contacts the uppermost sheet S1 of the sheets S supported on the sheet feed tray 31. Further, the revolution of the feed roller 32 causes the leading end regulation member 35 to swing downstream D in the sheet conveyance direction, to be retracted from the sheet conveyance path. Thereby, the uppermost sheet S1 is fed, and the sheet S1 passes the feed roller 32 and through the nip portion 33n of the separation unit 33 to be is conveyed to the pre-secondary-transfer conveyance path 51. Thereafter, the pickup arm 37 is lifted to prepare for the feeding of the next sheet S.

In a state where the uppermost sheet S1 is fed, the second sheet S2 may be subjected to double feed with the upper sheet S1 to the separation unit 33, due to the own weight of the sheet S2 and a frictional force with the uppermost sheet S1. In that case, as illustrated in FIG. 4B, the uppermost sheet S1 is separated at the separation unit 33 and conveyed to the pre-secondary-transfer conveyance path 51, while the sheet S2 is stopped at a position abutted against the separation unit 33. By having the sheet S2 move to a position abutted against the separation unit 33, the retractable portion 34b of the trailing end regulation member 34 will no longer be pressed by the sheet S2, so that it protrudes from the sheet support surface 31a, that is, to the regulating position 341.

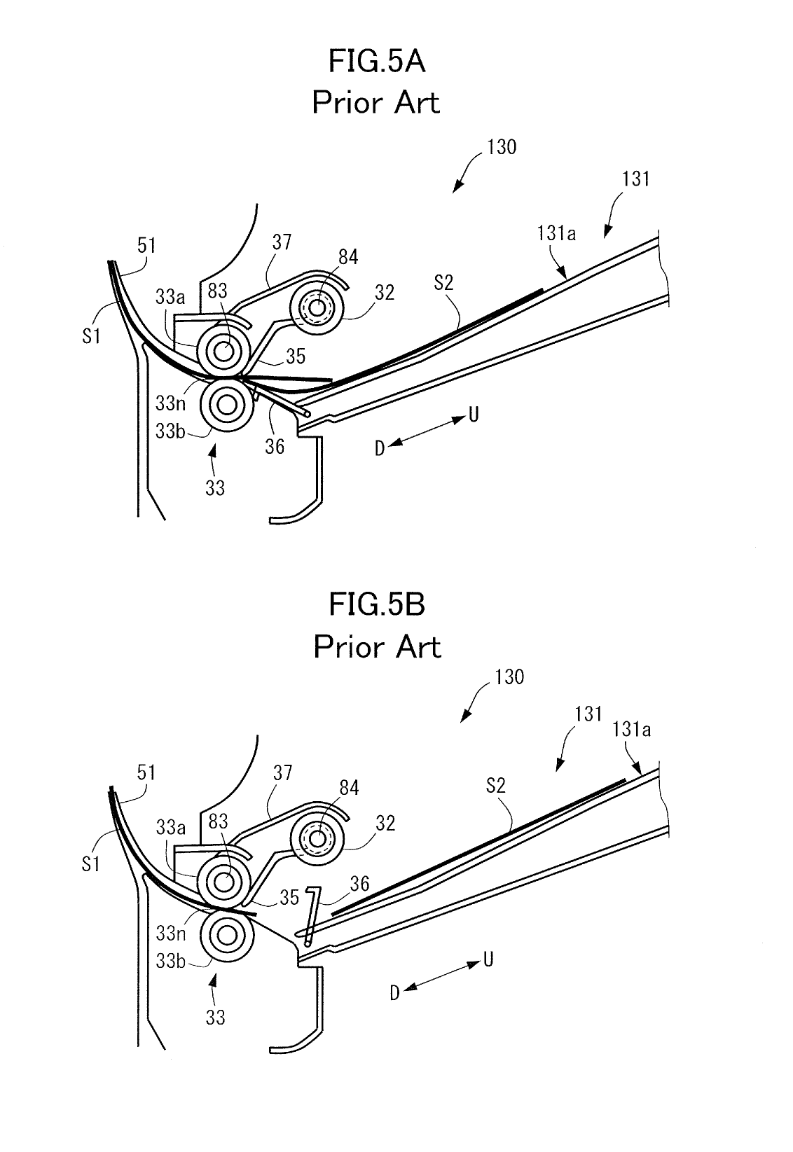

In a state where two sheets, sheet S1 and sheet S2, are supported on the sheet feed tray 31, a phenomenon may occur where the second sheet S2 retreats upstream U in the sheet conveyance direction during sheet feed. This phenomenon will be described in detail with respect to FIGS. 5A and 5B. FIGS. 5A and 5B illustrate a manual sheet feed portion 130 having a sheet feed tray 131 not equipped with the trailing end regulation member 34. The manual sheet feed portion 130 has a similar configuration as the above-described manual sheet feed portion 30 except for the absence of the trailing end regulation member 34, so that it is denoted with the same reference numbers, and detailed descriptions are omitted.

In the manual sheet feed portion 130, in a state where the uppermost sheet S1 is fed, if the second sheet S2 is subjected to double feed by the uppermost sheet S1 to the separation unit 33, the trailing end portion of the uppermost sheet S1 deforms a leading end portion of the second sheet S2, as illustrated in FIG. 5A. Then, for example, force accumulated in the sheet S2 by the deformation may be released suddenly, or a trailing edge of the uppermost sheet S1 may flick the leading edge of the sheet S2. Thereby, the sheet S2 may retreat to a position not detectable by the detection lever 36 of the sheet presence detection sensor, as illustrated in FIG. 5B. Such retreating movement of the sheet S2 occurs especially when two sheets are supported on a sheet support surface 131a. In contrast, if three or more sheets are supported on the sheet support surface 131a, such retreating movement is relatively unlikely to occur, due to the difference between the frictional force among sheets and the frictional force between the sheet and the sheet support surface 131a, but the retreating movement is likely to occur when the number of sheets are reduced to the last two sheets.

In contrast, according to the manual sheet feed portion 30 of the present embodiment, as illustrated in FIG. 4B, in a case where only two sheets are supported, for example, if the second sheet S2 is subjected to double feed to the separation unit 33, the retractable portion 34b protrudes to the sheet support surface 31a. Therefore, even if the second sheet S2 attempts to retreat upstream U in the sheet conveyance direction, it abuts against the retractable portion 34b, so that the sheet is prevented from retreating to a position not detectable by the detection lever 36 of the sheet presence detection sensor.

As described, according to the present embodiment, the retractable portion 34b of the trailing end regulation member 34 capable of regulating the movement of the sheet S supported on the sheet support surface 31a from moving upstream U in the sheet conveyance direction is formed retractable with respect to the sheet support surface 31a. In a state where at least one of the sheets supported on the sheet support surface 31a is positioned at the reference position, the retractable portion 34b of the trailing end regulation member 34 is pushed down into the sheet support surface 31a by the at least one of the sheets. Therefore, in a state where the user removes the sheets remaining on the sheet feed tray 31 at an end of the image forming process, for example, the sheets will not be caught by the trailing end regulation member 34, and the workability can be improved. That is, when sheets are supported on the sheet feed tray 31, the retractable portion 34b of the trailing end regulation member 34 is arranged at a position not protruded to the sheet support surface 31a, so that the deterioration of workability can be prevented.

Furthermore, in a case where all the sheets supported on the sheet support surface 31a are displaced toward the separation unit 33 from the reference position, the retractable portion 34b of the trailing end regulation member 34 protrudes from the sheet support surface 31a and regulates the sheet from moving upstream U in the sheet conveyance direction. Therefore, even if the uppermost sheet S1 of the stacked sheets causes the second sheet S2 to be double-fed to the separation unit 33, and the uppermost sheet S1 flicks the second sheet S2 and causes the sheet S2 to retreat upstream, the retractable portion 34b of the trailing end regulation member 34 prevents the second sheet S from retreating upstream.

As described, according to the present embodiment, even by providing the trailing end regulation member 34 on the sheet feed tray 31, the workability of removing the sheets supported on the sheet support surface 31a can be improved. A similar effect can also be exerted by the sheet feeding unit 20.

Further according to the present embodiment, the trailing end regulation member 34 also serves as a sheet size sensor, so that the increase in size and cost of the apparatus caused by the increase in the number of components can be suppressed.

According even further to the present embodiment, the retractable portion 34b of the trailing end regulation member 34 is arranged at a position overlapped with the trailing end portion of a postcard placed at the reference position. Therefore, in a state where a postcard, having a small size and deteriorated workability, and which is thick so that the force in which the uppermost sheet S1 flicks the second sheet S2 is strong, is used, the improvement of workability and ensured trailing end regulating ability can be realized most effectively.

The present embodiment described above illustrates a case where the trailing end regulation member 34 also serves as a sheet size sensor, but the present invention is not restricted to this example, and the trailing end regulation member 34 can be provided as an independent member as the sheet size sensor.

Further, the present embodiment described above has illustrated a case where the trailing end regulation member 34 revolves around the support shaft 34a so that the retractable portion 34b is retractable with respect to the sheet support surface 31a, but the present invention is not restricted to this example. For example, the trailing end regulation member 34 can be designed to move along a straight line to form the retractable portion retractable with respect to the sheet support surface 31a.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-205463, filed Oct. 19, 2015 which is hereby incorporated by reference herein in its entirety.

What is claimed is:

1. A sheet feeding apparatus comprising:
a sheet supporting portion comprising a sheet support surface configured to support a sheet;
a feed roller configured to abut against and feed an uppermost sheet of sheets supported on the sheet support surface;
a separation unit arranged downstream, in a sheet conveyance direction, of the feed roller, and configured to separate and convey the sheets fed via the feed roller one by one; and
a regulation unit configured to move between a regulating position where the regulation unit is protruded from the sheet support surface and regulates a sheet supported on the sheet support surface from moving upstream in the sheet conveyance direction, and a retracted position where the regulation unit is pushed down into the sheet support surface from the regulating position,
wherein the regulation unit is configured to be pushed down by a sheet positioned at a reference position on the sheet support surface, and in a case where the sheet moves from the reference position toward the separation unit and is not present on the regulation unit, the regulation unit moves from the retracted position to the regulating position to regulate the movement of the sheet.

2. The sheet feeding apparatus according to claim 1,
wherein the regulation unit is arranged at a position overlapped with an upstream end portion of a minimum sized sheet placed at the reference position.

3. The sheet feeding apparatus according to claim 1,
wherein the regulation unit is arranged at a position satisfying a relationship of L1>Ls, where a distance from the regulation unit to the separation unit is denoted as Ll, and a length in a sheet conveyance direction of a minimum sized sheet is denoted as Ls.

4. The sheet feeding apparatus according to claim 1,
wherein the regulation unit comprises an abutment surface configured so that a sheet abuts against the abutment surface from a downstream side in the sheet conveyance direction, and form an acute angle with respect to the sheet support surface, in a case where the regulation unit is positioned at the regulating position.

5. The sheet feeding apparatus according to claim 4,
wherein the abutment surface is inclined 60 to 80 degrees with respect to the sheet support surface.

6. The sheet feeding apparatus according to claim 1, further comprising
a biasing unit configured to bias the regulation unit toward the regulating position,
wherein the regulation unit is supported pivotably by a support shaft, and
a biasing force of the biasing unit is set so that the regulation unit is positioned at the retracted position in a case where a single sheet is placed on the regulation unit.

7. The sheet feeding apparatus according to claim 1, further comprising a sheet presence detection unit disposed between a downstream end portion of the reference position and the separation unit, and configured to detect whether a sheet is placed on the sheet support surface.

8. The sheet feeding apparatus according to claim 1,
wherein the regulation unit also serves as a sheet size detection unit configured to detect whether a length in the sheet conveyance direction of the sheet supported on the sheet support surface is longer or shorter than a predetermined length, based on whether the regulation unit is projected or retracted from the sheet support surface.

9. The sheet feeding apparatus according to claim 1, further comprising
a downstream end regulation unit configured to abut against a downstream end of the sheet supported on the sheet support surface to position the sheet at the reference position in the sheet conveyance direction, and in a case where the feed roller and the separation unit are operated, allow the sheet to move downstream in the sheet conveyance direction from the reference position.

10. The sheet feeding apparatus according to claim 9,
wherein the downstream end regulation unit is arranged at a position satisfying a relationship of Ls>L2, where a distance from the regulation unit to the downstream end regulation unit is denoted as L2 and a length in a sheet conveyance direction of a minimum sized sheet is denoted as Ls.

11. The sheet feeding apparatus according to claim 1,
wherein the sheet supporting portion is a manual sheet-feeding tray.

12. A sheet feeding apparatus comprising:
a sheet supporting portion comprising a sheet support surface configured to support a sheet;
a feed roller configured to abut against and feed an uppermost sheet of sheets supported on the sheet support surface;
a separation unit arranged downstream, in a sheet conveyance direction, of the feed roller, and configured to separate and convey the sheet fed via the feed roller one by one;
a regulation unit configured to move between a regulating position where the regulation unit protrudes from the sheet support surface and regulates a sheet supported on a sheet support surface from moving upstream in the sheet conveyance direction of the sheet, and a retracted position where the regulation unit is pushed down into the sheet support surface from the regulating position; and
a downstream end regulation unit configured to abut against a downstream end of a sheet supported on the sheet support surface and position the sheet at a reference position in the sheet conveyance direction, and in a case where the feed roller and the separation unit are operated, allow the sheet to move downstream in the sheet conveyance direction from the reference position,
wherein the regulation unit is arranged at a position satisfying a relationship of L1>Ls, and the downstream end regulation unit is arranged at a position satisfying a relationship of Ls>L2, in a state where a distance from the regulation unit to the separation unit is denoted as L1, a distance from the regulation unit to the downstream end regulation unit is denoted as L2, and a length in a sheet conveyance direction of a minimum sized sheet is denoted as Ls.

13. A sheet feeding apparatus comprising:
a sheet supporting portion comprising a sheet support surface configured to support a sheet;
a feed roller configured to abut against and feed an uppermost sheet of sheets supported on the sheet support surface;
a separation unit arranged downstream, in a sheet conveyance direction, of the feed roller, and configured to separate and convey the sheet fed via the feed roller one by one;
a regulation unit configured to regulate a sheet supported on the sheet support surface from moving upstream in the sheet conveyance direction;
wherein the regulation unit is configured retractably with respect to the sheet support surface,
wherein in a state where the sheet supported on the sheet support surface is positioned at a reference position, the regulation unit is pushed down into the sheet support surface by the sheet, and
wherein in a state where all the sheets supported on the sheet support surface are displaced toward the separation unit from the reference position, the regulation unit protrudes from the sheet support surface and regulate the sheet from moving upstream in the sheet conveyance direction.

14. The image forming apparatus comprising:
an image forming unit configured to form an image on a sheet; and
the sheet feeding apparatus according to claim 1 configured to feed a sheet to the image forming unit.
